(19) United States
(12) Patent Application Publication
(10) Pub. No.: US 2012/0268027 A1
(43) Pub. Date: Oct. 25, 2012

(54) ENERGY SAVING LED HAVING DIMMING FUNCTION AND MOOD-LIGHTING CONTROL FUNCTION

(76) Inventor: Hyun Min Shin, Mapo-gu (KR)

(21) Appl. No.: 13/511,109

(22) PCT Filed: Nov. 23, 2010
(86) PCT No.: PCT/KR2010/008291

§ 371 Date: May 21, 2012

(30) Foreign Application Priority Data
Nov. 26, 2009 (KR) 10-2009-0115403
Dec. 14, 2009 (KR) 10-2009-0124163
Dec. 14, 2009 (KR) 10-2009-0124201
Nov. 10, 2010 (KR) 10-2010-0111704

(51) Int. Cl. H05B 37/02

(52) U.S. Cl. 315/224

(57) ABSTRACT

An energy saving LED lamp is disclosed. The LED lamp can control dimming or mood-lighting operation through repeated on/off operations of a simple power switch currently installed in a building, thereby eliminating requirement for any additional labor to change the existing switch or device for obtaining a dimming function or mood-lighting control function.

### TECHNICAL FIELD

The present invention relates to an energy saving LED lamp having a dimming function or mood-lighting control function with a power switch. More particularly, the present invention relates to an energy saving LED lamp that can control dimming or mood-lighting operation of the LED lamp through repeated on/off operations of a simple power switch currently installed in a building, thereby eliminating requirement for any additional labor to change the existing switch or device to obtain a dimming function or mood-lighting control function.

### BACKGROUND ART

In general, humans obtain about 70% of daily life information through vision. Colors of an object recognized through vision have a great effect on emotion and perception. Humans have a natural tendency to associate colors with specific memories or feelings. Accordingly, as lighting determines the perceived color of an object to some extent, lighting has an important effect on the human emotional state. Further, reports say that since lighting conditions may change the brainwaves of workers, the color temperature of lighting directly affects worker fatigue (Lim Suk-ki et al., Evaluation of worker fatigue depending on color temperature of lighting, Korean Society for Emotion & Sensibility Journal, 2001).

As has been found through such medical research, excessively bright or dark lighting and colors have a considerable impact on the physical and emotional state of humans and lighting may make a person comfortable or enhance working efficiency.

Recently, by taking an emotion stimulating function of lighting into account, various studies have focused upon developing lighting that can not only provide simple illumination, but also emit light of various colors capable of stimulating the emotions. Further, since persons may have different emotions with respect to color and intensity of illumination, there is a need for lighting fixtures allowing a user to make easy and free adjustment of lighting in order to obtain desired lighting moods.

In general, interior lighting fixtures such as fluorescent, halogen, and incandescent lamps are installed on the ceiling or the wall of a building. Although such interior lighting fixtures are commonly used for interior illumination, they have problems of high power consumption and simple monochromatic illumination.

To solve the problems of the incandescent and halogen lights such as high power consumption and monotonous color, light emitting diode (LED) lamps consuming less power and emitting various colors have been developed and widely used.

Generally, LEDs are produced through semiconductor manufacturing processes and have many advantages such as low power consumption and long lifespan as compared with conventional light sources. In recent years, application of LEDs has expanded to many fields, thereby replacing conventional fluorescent or incandescent lamps.

However, in order to allow a user to adjust the intensity of illumination and color of lighting with the LED lamps so as to obtain various desired lighting moods as mentioned above, it is necessary not only to replace conventional lighting, but also to provide a separate switch or control device.

Further, as in the fluorescent and incandescent lamps, the LED lamp has been increasingly required to have a dimming control function as well as a simple on/off function. Currently, various methods are suggested to provide the dimming control function of the LED lamp. For example, in one method, dimming control is obtained through user manipulation using a dimming controller or a remote controller to adjust brightness stepwise or continuously.

Further, to control output of the LED lamp, the brightness of the LED lamp is adjusted through variation or phase modulation of voltage supplied to the LED lamp. For variation of the voltage, an A/D converter is employed to convert an alternating current through a transformer circuit including a trans-coil. However, this technique also has a problem in that a significantly greater size of the trans-coil than that of the LED module results in an increase in the size of the LED module.

To solve this problem, a smaller and lighter converting circuit than the existing transformer has been developed which uses a switching mode power supply (SMPS) to convert AC power to high frequency DC power. However, the SMPS requires significantly large current capacity to cause high energy loss and is very expensive.

As such, conventionally, realization of the dimming function for the LED lamp requires an expensive dimming device and cannot be achieved using the existing electric wire harness.

### DISCLOSURE OF INVENTION

### Technical Problem

The present invention is conceived to solve the problems of the related art, and an aspect of the invention is to provide an energy saving LED lamp that can control dimming operation or mood-lighting operation of the LED lamp based on an ON/OFF switching cycle and ON/OFF switching repetition time of an existing power switch generally installed in a house, thereby allowing a user to easily adjust brightness or color of the LED lamp using an existing wire harness without a separate dimming controller, dimming LED lamp, controlling wire, mood-lighting device, or the like.

### Solution to Problem

In accordance with an aspect of the present invention, an energy saving LED dimming lamp using a power switch includes: an LED module emitting light; a power switch turning on/off AC power supplied to the LED module; a power converter converting the AC power to DC power with the power switch turned on; a charging unit connected to the power converter to be charged with the supplied power while the power switch is turned on; a timer connected to the charging unit to measure an ON/OFF switching cycle and an ON/OFF switching repetition number of the power switch; and a controller connected to the power converter and the charging unit to control brightness of the LED module according to the ON/OFF switching cycle and repetition number of the power switch measured by the timer.

The controller may include a program that sets the brightness of the LED module according to the ON/OFF switching repetition number of the power switch in a preset period.

The timer may send a power-off signal to the controller if the power switch is not turned on within a preset period from a state that the power switch is turned off, and may send the ON/OFF switching cycle and repetition number of the power switch to the controller if the power switch is repeatedly turned on/off within a preset period.

The charging unit may supply the power to the controller and the timer for a preset time with the power switch turned off.

The LED dimming lamp may further include a dimming circuit that generates a dimming signal according to the ON/OFF switching cycle and repetition number of the power switch sent from the timer and controller.

In accordance with another aspect of the present invention, an energy saving LED lamp having a mood-lighting control function using a power switch includes: an LED module emitting light; a power switch turning on/off electrical power supplied to the LED module; a power converter converting the power to an electric current suitable for the LED module when the power is supplied to the LED module with the power switch turned on; a charging unit connected to the power converter to be charged with the supplied power while the power switch is turned on; a timer connected to the charging unit to measure an ON/OFF switching cycle and an ON/OFF switching repetition number of the power switch; and a controller connected to the power converter, the timer and the charging unit to control the LED module according to a mood-lighting mode determined depending on the ON/OFF switching cycle and repetition number of the power switch sent from the timer.

The controller may include a mood-lighting control program that sets brightness or color of the LED module according to the ON/OFF switching repetition number of the power switch in a preset period.

The timer may send a power-off signal to the controller if the power switch is not turned on within a preset period from a state that the power switch is turned off, and may send the ON/OFF switching cycle and repetition number of the power switch to the controller if the power switch is repeatedly turned on/off within a preset period.

The charging unit may supply the power to the controller and the timer for a preset time with the power switch turned off to allow the controller and the timer to normally operate even when the power switch is turned off.

The LED lamp may further include a mood-lighting signal generating circuit that generates a mood-lighting control signal according to the ON/OFF switching cycle and repetition number of the power switch sent from the timer and controller.

In accordance with a further aspect of the present invention, an energy saving LED dimming lamp using a power switch includes: a charging unit connected to a power converter to be charged with supplied power, with a power switch for regulating an external power source turned on, the power converter converting AC power to DC power when the AC power is supplied to the LED lamp through the power switch; and a controller connected to the charging unit and the LED lamp and measuring an ON/OFF switching cycle and repetition number of the power switch to control brightness of the LED lamp.

The controller may include a program that recognizes the ON/OFF switching repetition number of the power switch in a preset period as a dimming control signal and determines the brightness of the LED module in response to the dimming control signal.

The controller may further include a timer connected to the charging unit and the power switch to measure the ON/OFF switching cycle and the ON/OFF switching repetition number of the power switch. The controller may send a power-off signal if the power switch is not turned on within a preset period from a state that the power switch is turned off, and may send a dimming control signal corresponding to the ON/OFF switching cycle and repetition number of the power switch if the power switch is repeatedly turned on/off within a preset period.

The LED dimming lamp may further include a dimming circuit that generates the dimming control signal corresponding to the ON/OFF switching cycle and repetition number of the power switch.

The charging unit may supply the power to the controller for a preset time with the power switch turned off to allow the controller to operate normally even when the power switch is off and to recognize ON/OFF switching operation of the power switch as the dimming control signal.

In accordance with yet another aspect of the present invention, an energy saving LED lamp having a mood-lighting control function using a power switch includes: a charging unit connected to a power converter to be charged with supplied power, with a power switch for regulating an external power source turned on, the power converter converting AC power to DC power when the AC power is supplied to the LED lamp through the power switch; and a controller connected to the charging unit and the LED lamp to control the LED lamp according to a mood-lighting mode determined depending on the ON/OFF switching cycle and repetition number of the power switch.

The controller may include a mood-lighting control program that sets brightness or color of the LED lamp according to the ON/OFF switching repetition number of the power switch in a preset period.

The controller may further include a timer connected to the charging unit and the power switch to measure the ON/OFF switching cycle and the ON/OFF switching repetition number of the power switch. The controller may send a power-off signal if the power switch is not turned on within a preset period from a state that the power switch is turned off, and may send a mood-lighting control signal corresponding to the ON/OFF switching cycle and repetition number of the power switch if the power switch is repeatedly turned on/off within a preset period.

The LED lamp may further include a mood-lighting signal generating circuit that generates a mood-lighting control signal according to the ON/OFF switching cycle and repetition number of the power switch sent from the timer and controller.

The charging unit may supply the power to the controller for a preset time with the power switch turned off to allow the controller to normally operate despite a turned off state of the power switch.

### Advantageous Effects of Invention

According to one embodiment, since the LED lamp uses an existing power switch normally installed in a building, it is not necessary to install an extra dimming or mood-lighting control device for the dimming or mood-lighting control function of the LED lamp. Therefore, existing lamps can be replaced with environmentally friendly and highly energy efficient LED lamps without any cost for installation of an additional dimming system.

Namely, the LED lamp according to the embodiment offers low power consumption, thereby not only satisfying national clean energy policies through a significant reduction in maintenance cost and extension of lifetime, but also contributing to reduction of carbon dioxide emissions in accordance with the Kyoto protocol for decreasing greenhouse gas emissions.

Further, since the LED lamp according to the embodiment enables dimming operation and mood-lighting control operation using the existing power switch, the LED lamp more efficiently reduces energy consumption than the conventional LED lamps. Moreover, the LED lamp according to the embodiment allows easy replacement for achieving the dimming function and the mood-lighting control function by simply replacing a current lamp with the LED lamp.

### BRIEF DESCRIPTION OF DRAWINGS

The above and other aspects, features and advantages of the invention will become apparent from the following detailed description in conjunction with the accompanying drawings, in which:

FIG. 1 is a diagram of an energy saving LED lamp using an existing power switch according to one embodiment of the present invention;

FIG. 2 is block diagram of the LED lamp according to the embodiment of the present invention;

FIG. 3 is a diagram of an energy saving LED lamp using an existing power switch according to another embodiment of the present invention; and

FIG. 4 is block diagram of the LED lamp according to the other embodiment of the present invention.

### MODE FOR THE INVENTION

Embodiments of the invention will now be described in detail with reference to the accompanying drawings.

### Embodiment 1

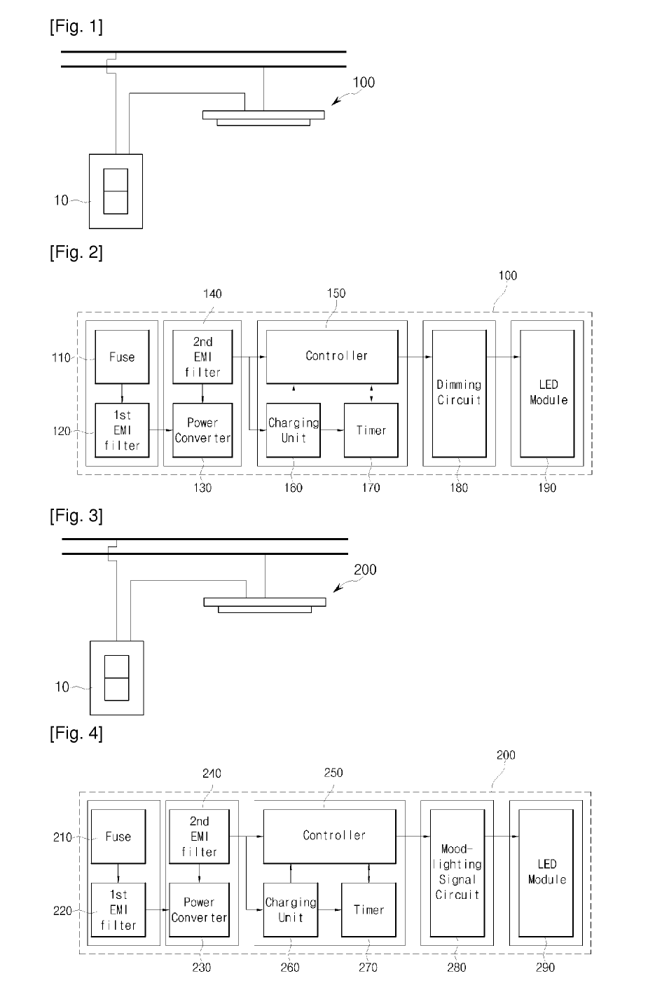

Referring to FIG. 1, an energy saving LED lamp 100 with a dimming function according to one embodiment can realize the dimming function through an electric wire harness as is used with any existing power switch currently installed in a building. Herein, an existing power switch 10 refers to a general power switch that is installed for a desk lamp or in buildings such as houses, hotels, factories, etc., and simply turns on/off AC power supplied from an external power source. For example, the existing power switch includes power ON/OFF switches such as general lighting switches, lighting switches for desk lamps, mood-lighting switches and touch lighting switches that are generally installed in buildings such as houses, hotels, factories, and the like.

Referring to FIGS. 1 and 2, the energy saving LED dimming lamp 100 according to this embodiment includes an LED module 190, a power converter 130, a charging unit 160, a timer 170, and a controller 150.

The LED module 190 is made using a general LED chip and any available LED module may be used as the LED module 190. The LED module 190 may be realized in different forms such as a fluorescent lamp type and a plane light type.

The power converter 130 converts AC power to DC power while the power switch 10 is turned on. Typically, the power converter 130 may have various structures to convert the AC power to the DC power, such as general transformer type, SMPC, AC exclusive type, DC exclusive type, or parallel circuit driving type using plural LEDs.

In the embodiment, as shown in FIG. 2, the energy saving LED lamp 100 may include first and second EMI filters 120, 140 at front and rear ends of the power converter 130 to intercept electromagnetic waves, and may further include a fuse 110.

The charging unit 160 is connected to the power converter 130 and charged with the supplied power while the power switch 10 is turned on. According to this embodiment, since the dimming function of the energy saving LED lamp 100 is controlled through repeated ON/OFF operations, it is necessary for the controller 150, the timer 170 and the like to operate normally even when the power switch 10 is turned off. Thus, the charging unit 160 stores enough power for the controller 150 and the timer 170 while the power switch 10 is turned on, and supplies the power to the controller 150 and the timer 170 when the power switch 10 is turned off. The charging unit 160 may be a rechargeable secondary battery.

The timer 170 is connected to the charging unit 160 and measures an ON/OFF switching cycle and an ON/OFF switching repetition number of the power switch 10 to transmit obtained information to the controller 150 and a dimming circuit 180 described below. Specifically, the timer 170 measures the ON/OFF switching cycle of the power switch 10 based on a time difference between a power turning-on operation and a power turning-off operation of the power switch 10 within a preset period, and counts the ON/OFF switching repetition number of the power switch 10 when the power switch 10 is repeatedly turned on/off in a preset period. Then, the timer 170 transmits the cycle and the repetition number to the controller 150.

Meanwhile, if the power switch is not turned on again in a preset period from the state that the power switch 10 is turned off, the timer 170 determines that a user wants to turn off the LED lamp, and transmits a power-off signal to the controller 150.

The controller 150 is a component for operating the LED module 190 and may be realized by a microcontroller or the like, which can be provided to the LED lamp. In this embodiment, the controller 150 enables the dimming function as well as general functions described above. That is, as shown in FIG. 2, the controller 150 is connected to the power converter 130 and the charging unit 160 to control the dimming operation of the LED module 190 in accordance with the ON/OFF switching cycle and repetition number of the power switch 10 measured and sent from the timer 170.

In order to realize such operations, the controller 150 includes a program for controlling brightness of the LED module 190 according to the ON/OFF switching repetition number of the power switch 10 in a preset period. The program analyzes information of the ON/OFF switching cycle and repetition number of the power switch 10 sent from the timer 170, and controls the dimming operation of the LED lamp corresponding to the ON/OFF switching cycle and repetition number of the power switch.

According to the embodiment, as shown in FIG. 2, the energy saving LED dimming lamp 100 may further include the dimming circuit 180 to generate a dimming signal in relation to the ON/OFF switching cycle and repetition number of the power switch 10 sent from the timer 170 and the controller 150. The dimming circuit 180 recognizes the ON/OFF switching repetition number of the power switch 10 through the timer 170 and the controller 150 and controls the brightness of the LED lamp as programmed in the controller 150.

### Embodiment 2

Referring to FIG. 3, an energy saving LED lamp 200 with a mood-lighting control function according to another embodiment can realize the mood-lighting control function through an electric wire harness as is used with any existing power switch currently installed in a building. Herein, the existing power switch 10 refers to a general power switch that simply turns on/off AC power supplied from an external power source. For example, the existing power switch includes power ON/OFF switches such as general lighting switches, lighting switches for desk lamps, mood-lighting switches and touch lighting switches that are generally installed in buildings such as houses, hotels, factories, and the like.

Referring to FIGS. 3 and 4, the energy saving LED lamp 200 with the mood-lighting control function according to this embodiment includes an LED module 290, a power converter 230, a charging unit 260, a timer 270, and a controller 250.

The LED module 290 is made using a general LED chip and any available LED module may be used as the LED module 290. The LED module 290 may be realized in different forms such as a fluorescent lamp type and a plane light type. According to this embodiment, the LED module 290 may include a plurality of different LED chips for emitting different colors to realize various intensities of illumination and colors from the single LED module 290.

The power converter 230 converts an electric power to an electric current suitable for operating the LED module 290, when the power is supplied to the LED lamp from an external power source, with the power switch 10 turned on. Typically, the power converter 230 may have various structures to convert the AC power to the DC power, such as general transformer type, SMPC, AC exclusive type, DC exclusive type, or parallel circuit driving type using plural LEDs.

In the embodiment, as shown in FIG. 4, the energy saving LED lamp 200 may include first and second EMI filters 220, 240 at front and rear ends of the power converter 230 to intercept electromagnetic waves, and may further include a fuse 210.

The charging unit 260 is connected to the power converter 230 and is charged with the supplied power while the power switch 10 is turned on. According to this embodiment, since the mood-lighting control function of the energy saving LED lamp 200 is controlled through repeated ON/OFF operations, it is necessary for the controller 250, the timer 270 and the like to operate normally even when the power switch 10 is turned off. Thus, the charging unit 260 stores enough power for the controller 250 and the timer 270 while the power switch 10 is turned on, and supplies the power to the controller 250 and the timer 270 when the power switch 10 is turned off. The charging unit 260 may be a rechargeable secondary battery.

The timer 270 is connected to the charging unit 260 and measures an ON/OFF switching cycle and an ON/OFF switching repetition number of the power switch 10 to transmit obtained information to the controller 250 and a mood-lighting control circuit 280 described below. Specifically, the timer 270 measures the ON/OFF switching cycle of the power switch 10 based on a time difference between a power on operation and a power off operation of the power switch 10 within a preset period, and counts the ON/OFF switching repetition number of the power switch 10 when the power switch 10 is repeatedly turned on/off in a preset period. Then, the timer 270 transmits the cycle and the repetition number to the controller 250.

Meanwhile, if the power switch 10 is not turned on again in a preset period from the state that the power switch 10 is turned off, the timer 270 determines that a user wants to turn off the LED lamp, and transmits a power-off signal to the controller 250.

The controller 250 is a component for operating the LED module 290 and may be realized by a microcontroller or the like, which can be provided to the LED lamp. In this embodiment, the controller 250 enables the mood-lighting control function as well as general functions described above. That is, as shown in FIG. 4, the controller 250 is connected to the power converter 230, the timer 270 and the charging unit 260 to control the brightness and color of the LED module 290 as the mood-lighting control function in accordance with the ON/OFF switching cycle and repetition number of the power switch 10 measured and sent from the timer 270.

In order to realize such operations, the controller 250 includes a mood-lighting control program for setting brightness and color of the LED module 290 according to the ON/OFF switching repetition number of the power switch 10 in a preset period. The mood-lighting control program may be realized in various ways for setting the brightness and color of the LED module 290. For example, the brightness and color of the LED module 290 may be adjusted by matching the ON/OFF switching repetition number of the power switch 10 to each of 10 types or less of intensity of illumination and colors preset by a user. In this way, the mood-lighting control program installed in the controller 250 analyzes information of the ON/OFF switching cycle and repetition number of the power switch 10 sent from the timer 270 and controls the brightness and color of the LED lamp according to the ON/OFF switching cycle and repetition number of the power switch.

According to the embodiment, as shown in FIG. 4, the energy saving LED lamp 200 may further include the mood-lighting control circuit 280 to generate a mood-lighting signal according to a mood-lighting pattern determined by the ON/OFF switching cycle and repetition number of the power switch 10 sent from the timer 270 and the controller 250. The mood-lighting control circuit 280 recognizes the ON/OFF switching repetition number of the power switch 10 through the timer 270 and the controller 250, generates a mood-lighting control signal matching the mood-lighting pattern corresponding to the repetition number of the power switch 10, and controls the brightness and color of the LED lamp in response to the mood-lighting control signal, as programmed in the controller 250.

Although some embodiments have been provided to illustrate the invention in conjunction with the drawings, it will be apparent to those skilled in the art that these embodiments are given by way of illustration only, and that that various modifications, changes, alterations, and equivalent embodiments can be made without departing from the spirit and scope of the invention. The scope of the invention should be limited only by the accompanying claims.

1. An energy saving LED dimming lamp using a power switch, comprising;
an LED module emitting light;
a power switch turning on/off AC power supplied to the LED module;
a power converter converting the AC power to DC power with the power switch turned on;
a charging unit connected to the power converter to be charged with the supplied power while the power switch is turned on;
a timer connected to the charging unit to measure an ON/OFF switching cycle and an ON/OFF switching repetition number of the power switch; and
a controller connected to the power converter and the charging unit to control brightness of the LED module according to the ON/OFF switching cycle and repetition number of the power switch measured by the timer.

2. The LED dimming lamp according to claim 1, wherein the controller comprises a program that sets the brightness of the LED module according to the ON/OFF switching repetition number of the power switch in a preset period.

3. The LED dimming lamp according to claim 1, wherein the timer sends a power-off signal to the controller if the power switch is not turned on within a preset period from a state that the power switch is turned off, and sends the ON/OFF switching cycle and repetition number of the power switch to the controller if the power switch is repeatedly turned on/off within a preset period.

4. The LED dimming lamp according to claim 1, wherein the charging unit supplies the power to the controller and the timer for a preset time with the power switch turned off.

5. The LED dimming lamp according to claim 1, further comprising:
a dimming circuit that generates a dimming signal according to the ON/OFF switching cycle and repetition number of the power switch transmitted from the timer and controller.

6. An energy saving LED lamp having a mood-lighting control function using a power switch, comprising;
an LED module emitting light;
a power switch turning on/off electrical power supplied to the LED module;
a power converter converting the power to an electric current suitable for the LED module when the power is supplied to the LED module with the power switch turned on;
a charging unit connected to the power converter to be charged with the supplied power while the power switch is turned on;
a timer connected to the charging unit to measure an ON/OFF switching cycle and an ON/OFF switching repetition number of the power switch; and
a controller connected to the power converter, the timer and the charging unit to control the LED module according to a mood-lighting mode determined depending on the ON/OFF switching cycle and repetition number of the power switch sent from the timer.

7. The LED lamp according to claim 6, wherein the controller comprises a mood-lighting control program that sets brightness or color of the LED module according to the ON/OFF switching repetition number of the power switch in a preset period.

8. The LED lamp according to claim 6, wherein the timer sends a power-off signal to the controller if the power switch is not turned on within a preset period from a state that the power switch is turned off, and sends the ON/OFF switching cycle and repetition number of the power switch to the controller if the power switch is repeatedly turned on/off within a preset period.

9. The LED lamp according to claim 6, wherein the charging unit supplies the power to the controller and the timer for a preset time with the power switch turned off

10. The LED dimming lamp according to claim 6, further comprising:
a mood-lighting signal generating circuit that generates a mood-lighting control signal according to the ON/OFF switching cycle and repetition number of the power switch sent from the timer and controller.

11. An energy saving LED dimming lamp using a power switch, comprising;
a charging unit connected to a power converter to be charged with supplied power, with a power switch for regulating an external power source turned on, the power converter converting AC power to DC power when the AC power is supplied to the LED lamp through the power switch; and
a controller connected to the charging unit and the LED lamp and measuring an ON/OFF switching cycle and repetition number of the power switch to control brightness of the LED lamp.

12. The LED dimming lamp according to claim 11, wherein the controller comprises a program that recognizes the ON/OFF switching repetition number of the power switch in a preset period as a dimming control signal and sets the brightness of the LED lamp in response to the dimming control signal.

13. The LED dimming lamp according to claim 11, wherein the controller further comprises a timer connected to the charging unit and the power switch to measure the ON/OFF switching cycle and the ON/OFF switching repetition number of the power switch, the controller sending a power-off signal if the power switch is not turned on within a preset period from a state that the power switch is turned off, and sending a dimming control signal corresponding to the ON/OFF switching cycle and repetition number of the power switch if the power switch is repeatedly turned on/off within a preset period.

14. The LED dimming lamp according to claim 13, further comprising:
a dimming circuit that generates the dimming control signal corresponding to the ON/OFF switching cycle and repetition number of the power switch.

15. The LED dimming lamp according to claim 11, wherein the charging unit supplies the power to the controller for a preset time with the power switch turned off.

16. An energy saving LED lamp having a mood-lighting control function using a power switch, comprising;
a charging unit connected to a power converter to be charged with supplied power, with a power switch for regulating an external power source turned on, the power converter converting AC power to DC power when the AC power is supplied to the LED lamp through the power switch; and
a controller connected to the charging unit and the LED lamp to control the LED lamp according to a mood-lighting mode determined depending on the ON/OFF switching cycle and repetition number of the power switch.

17. The LED lamp according to claim 15, wherein the controller comprises a mood-lighting control program that sets brightness or color of the LED lamp according to the ON/OFF switching repetition number of the power switch in a preset period.

18. The LED lamp according to claim 16, wherein the controller further comprises a timer connected to the charging unit and the power switch to measure the ON/OFF switching cycle and the ON/OFF switching repetition number of the power switch, the controller sending a power-off signal if the power switch is not turned on within a preset period from a state that the power switch is turned off, and sending a mood-lighting control signal corresponding to the ON/OFF switching cycle and repetition number of the power switch if the power switch is repeatedly turned on/off within a preset period.

19. The LED lamp according to claim 18, further comprising:
a mood-lighting signal generating circuit that generates a mood-lighting control signal according to the ON/OFF switching cycle and repetition number of the power switch sent from the timer and controller.

20. The LED lamp according to claim 16, wherein the charging unit supplies the power to the controller for a preset time with the power switch turned off.
